(19) United States
(12) Patent Application Publication
(10) Pub. No.: US 2007/0215526 A1
(43) Pub. Date: Sep. 20, 2007

(54) Screen device

(75) Inventor: Yoshihiko Aikawa, Shizuoka (JP)

Correspondence Address: KANESAKA BERNER AND PARTNERS LLP, 1700 DIAGONAL RD, SUITE 310, ALEXANDRIA, VA, 22314-2848, US

(73) Assignee: AIKAWA IRON WORKS CO.,LTD, Shizuoka (JP)

(21) Appl. No.: 11/509,760

(22) Filed: Aug. 25, 2006

(30) Foreign Application Priority Data
Mar. 20, 2006 (JP) 2006-076539

(51) Int. Cl. B07B 1/04; D21C 9/08

(52) U.S. Cl. 209/273; 162/55; 209/17; 209/283; 209/300

(57) ABSTRACT

A screen device includes a screen dividing a tank into a first chamber and a second chamber for sorting a foreign material in a papermaking material, a first papermaking material supply passage for supplying the papermaking material to the first chamber from the upper side, and a second papermaking material supply passage for supplying the papermaking material to the first chamber from the lower side. The papermaking material passing through the screen is ejected from a middle area of the screen. The screen device also includes an agitating member located inside the first chamber for agitating the papermaking material, and a foreign material outlet passage communicating with the first chamber through a foreign material outlet provided on a side face of the screen. Therefore, the screen device can improve the sorting effect between the foreign material and a good-quality fiber in the papermaking material.

### BACKGROUND OF THE INVENTION AND RELATED ART STATEMENT

The present invention relates to a screen device allowing a papermaking material to flow toward the outside of a screen from the inside of the screen, and refining the papermaking material, especially, a screen device improving the sorting effect between a foreign material and a good-quality fiber in the papermaking material.

Conventionally, in a screen device, for example, in the so-called outward-type screen device (centrifugal type) allowing a papermaking material to flow toward the outside of the screen from the inside of the screen, and refining the papermaking material, the papermaking material received inside the screen is agitated by an agitating member provided inside the screen, and the foreign material in the papermaking material is removed through the screen, so that the papermaking material is refined (for example, refer to Japanese Patent Publication No. 2004-137621 (FIG. 1)).

However, in the above-mentioned screen device, since water outflows through the screen on the upstream side of the papermaking material, the papermaking material is sequentially condensed as the papermaking material comes to the downstream side. Accordingly, the sorting effect by the screen deteriorates.

The object of the present invention is to provide a screen device being able to solve the above-mentioned problem.

Further objects and advantages of the invention will be apparent from the following description of the invention.

### SUMMARY OF INVENTION

A screen device of the present invention, according to a first aspect, includes a tank receiving a papermaking material; and a screen dividing the tank into a first chamber and a second chamber, for sorting a foreign material in the papermaking material. The screen has a cylindrical shape whose height is longer than the diameter with both open end portions, and includes circular holes or slit-like openings on the side face. The screen stands inside the tank in such a way that the height direction of the cylindrical shape orients in a vertical direction. Both open end portions of the screen are an upper opening and lower opening.

The screen device includes a first papermaking material supply passage, for supplying the papermaking material to the first chamber from the upper side, having a first papermaking material supply opening located on the upper side of the first chamber; and a second papermaking material supply passage, supplying the papermaking material to the first chamber from the lower side, having a second papermaking material supply opening located lower than the first papermaking material supply opening. The first papermaking material supply opening is located higher than the upper opening, and the second papermaking material supply opening is located lower than the lower opening, respectively.

The screen device also includes an agitating member located inside the first chamber on the inner side of the screen, and agitating the papermaking material inside the tank; a refined papermaking material outlet passage communicating with the second chamber and leading the refined papermaking material through the screen to the outside of the tank; and a foreign material outlet passage communicated with the first chamber through a foreign material outlet provided on the side face of the screen, and leading the foreign material in the papermaking material which does not pass through the screen to the outside of the tank.

Also, in the screen device in a second aspect, according to the first aspect, the foreign material outlet provided on the side face of the screen is located at half the height of the screen, and formed in an arc along the outer circumference of the screen.

Moreover, the screen device in a third aspect, according to the first or second aspect, includes a first dilution water passage communicated with the first chamber through a first dilution water inlet provided on the side face of the screen, and leading the dilution water into the screen; and a second dilution water passage communicated with the first chamber through a second dilution water inlet provided on the side face of the screen, and leading the dilution water into the screen. The first dilution water inlet is located on the upper side of the foreign material outlet, and the second dilution water inlet is located on the lower side of the foreign material outlet.

The agitating member includes a first cylinder portion including multiple first agitating portions on the side face; a second cylinder portion including multiple second agitating portions on the side face; and a third cylinder portion including multiple third agitating portions on the side face, sequentially from the top to the bottom of the tank. The foreign material outlet is located in a position facing the second cylinder portion, and the distance between the screen and the second cylinder portion is larger than the distance between the screen and the first cylinder portion and the distance between the screen and the third cylinder portion.

Conventionally, in the so-called outward-type screen device allowing the papermaking material to flow toward the outside of the screen from the inside of the screen and refining the papermaking material, the papermaking material is condensed as the papermaking material goes downward in the tank, so that the sorting effect by the screen deteriorates. However, according to the screen device in the first aspect, the first papermaking material supply opening is located higher than the upper opening of the screen, and the second papermaking material supply opening is located lower than the lower opening of the screen, respectively. Also, the screen device in the first aspect includes the foreign material outlet passage communicated with the first chamber through the foreign material outlet provided on the side face of the screen, and leading the foreign material in the papermaking material which does not pass through the screen to the outside of the tank.

As a result, in the so-called outward-type screen device allowing the papermaking material to flow toward the outside of the screen from the inside of the screen and refining the papermaking material, the distance between the supply opening (upper opening or lower opening) to the screen of the papermaking material and the outlet (foreign material outlet) shortens, so that the papermaking material is hard to be condensed, and the refining efficiency can be improved. Incidentally, as the papermaking material is condensed on the downstream side of the screen, clogging of the screen occurs and the refining efficiency deteriorates.

Also, according to the screen device in the second aspect, in addition to the effect of the invention in the first aspect, the foreign material outlet provided on the side face of the screen is located at half the height of the screen, and formed in the arc along the outer circumference of the screen, so that the foreign material in the papermaking material can be collected efficiently in the position of half the height of the screen. Moreover, the foreign material outlet can be widely provided, and clogging of the foreign material outlet can also be prevented.

In addition, according to the screen device in the third aspect, in addition to the effect of the invention in the first or second aspect, the foreign material outlet is located in the position facing the second cylinder portion, and the distance between the screen and the second cylinder portion is larger than the distance between the screen and the first cylinder portion and the distance between the screen and the third cylinder portion. As a result, as the space receiving the dilution water increases, the dilution effect of the condensed papermaking material can be enhanced and the refining efficiency can be improved.

### BRIEF DESCRIPTION OF THE DRAWINGS

FIG. 1 is a schematic plan view of a screen device of the first embodiment of the present invention;

FIG. 2 is a schematic cross sectional view taken along line 2-0-2 in FIG. 1;

FIG. 3 is a schematic cross sectional view taken along line 2-0-3 in FIG. 1;

FIG. 4 is a schematic cross sectional view taken along line 4-4 in FIG. 3;

FIG. 5 is a schematic partial cross sectional view of a screen in FIG. 1;

FIG. 6 is a schematic cross sectional view taken along line 6-6 in FIG. 5;

FIG. 7 is a partially enlarged schematic cross sectional view showing a portion in FIG. 2;

FIG. 8 is a schematic cross sectional view taken along line 8-8 in FIG. 7;

FIG. 9 is a schematic cross sectional view taken along line 9-9 in FIG. 2; and

FIG. 10 is a schematic cross sectional view of a screen device of another embodiment which is different from the screen device shown in FIGS. 1-9.

### DETAILED DESCRIPTION OF PREFERRED EMBODIMENTS

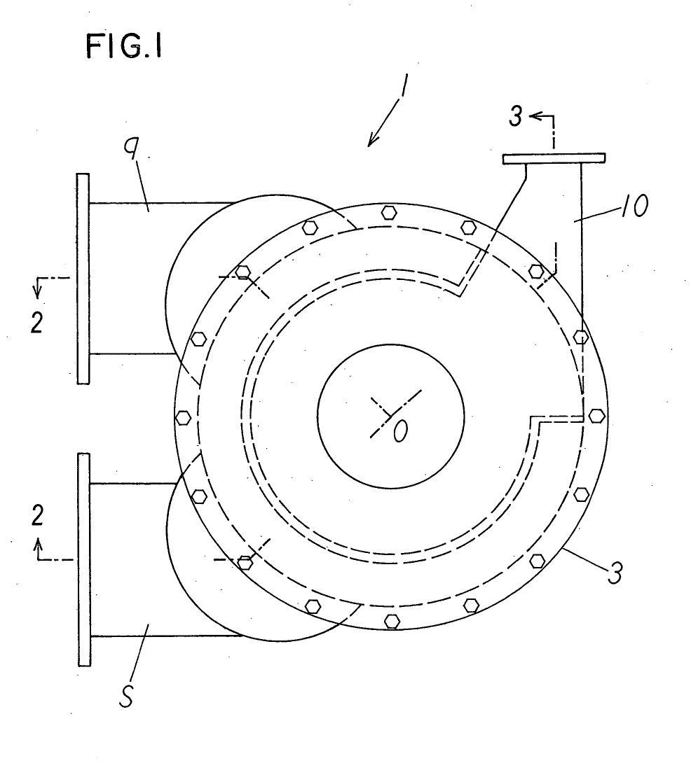

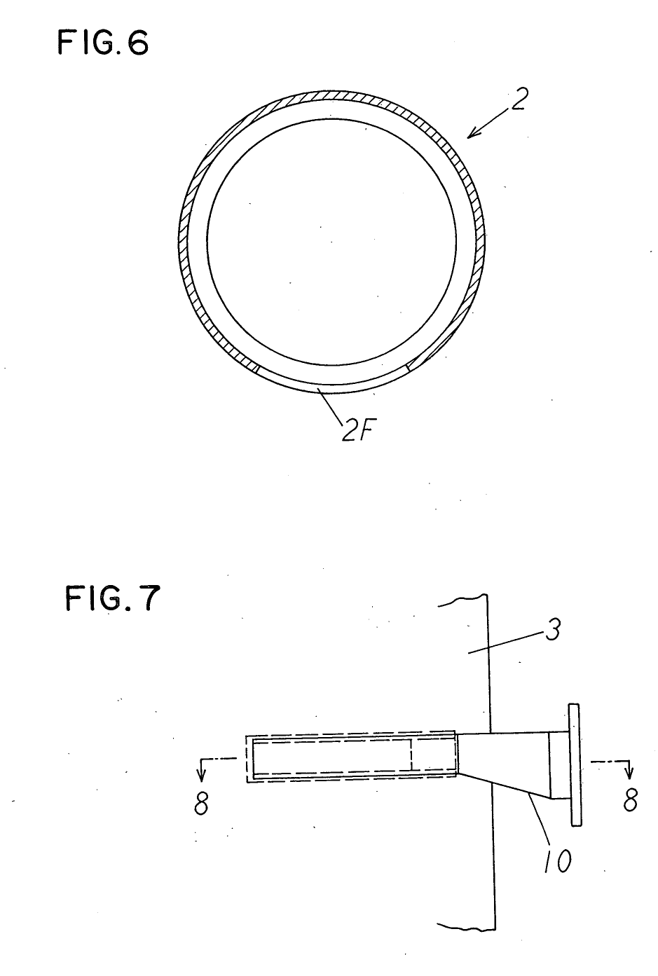

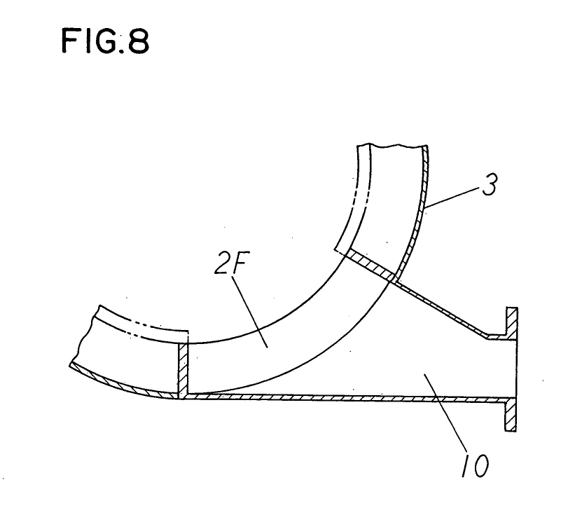

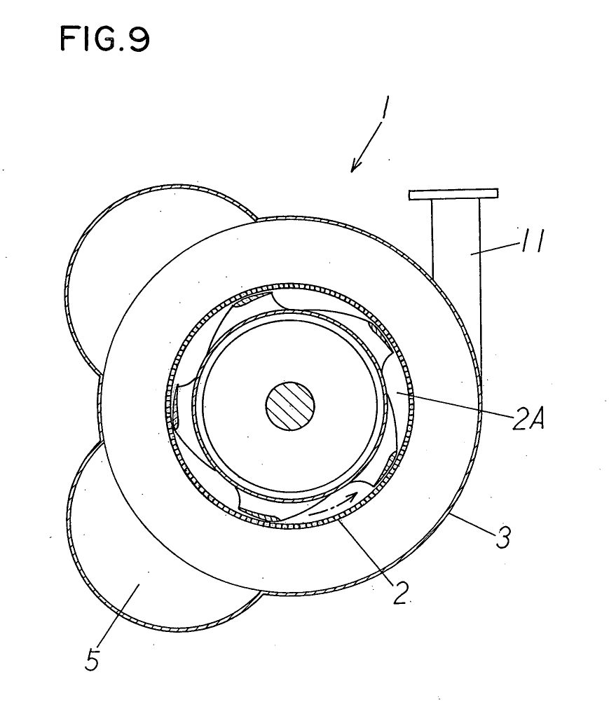

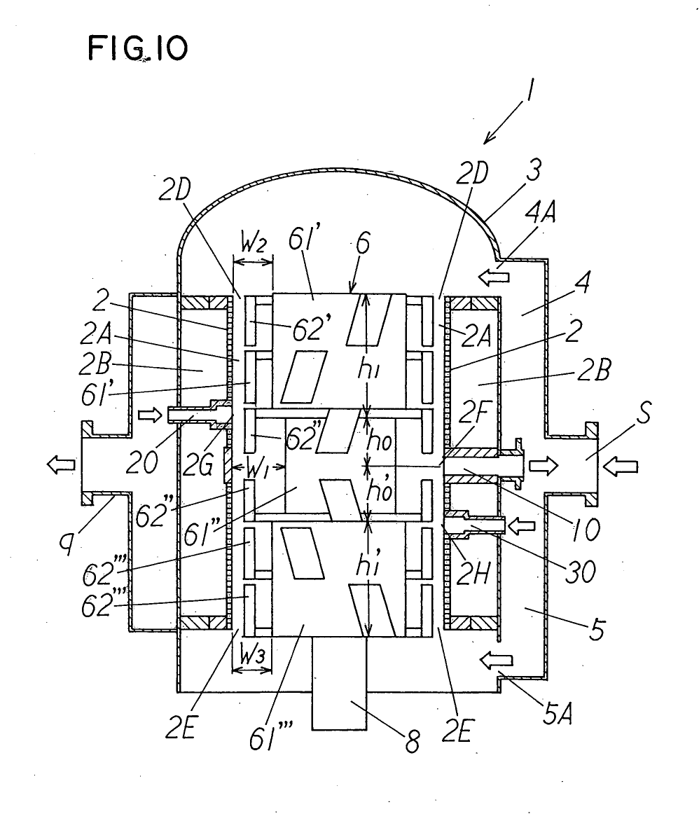

An embodiment of a screen device of the present invention will be explained with reference to the drawings. In FIGS. 1-9, the reference numeral 1 represents the screen device and the screen device 1 is a so-called outward-type screen device (centrifugal type) allowing a papermaking material to flow toward the outside of a screen 2 from the inside of the screen 2, and -refining the papermaking material. The screen device 1 removes a foreign material (for example, a plastic and so on) in the papermaking material (for example, used newspaper, used corrugated paper and so on), and refines the papermaking material.

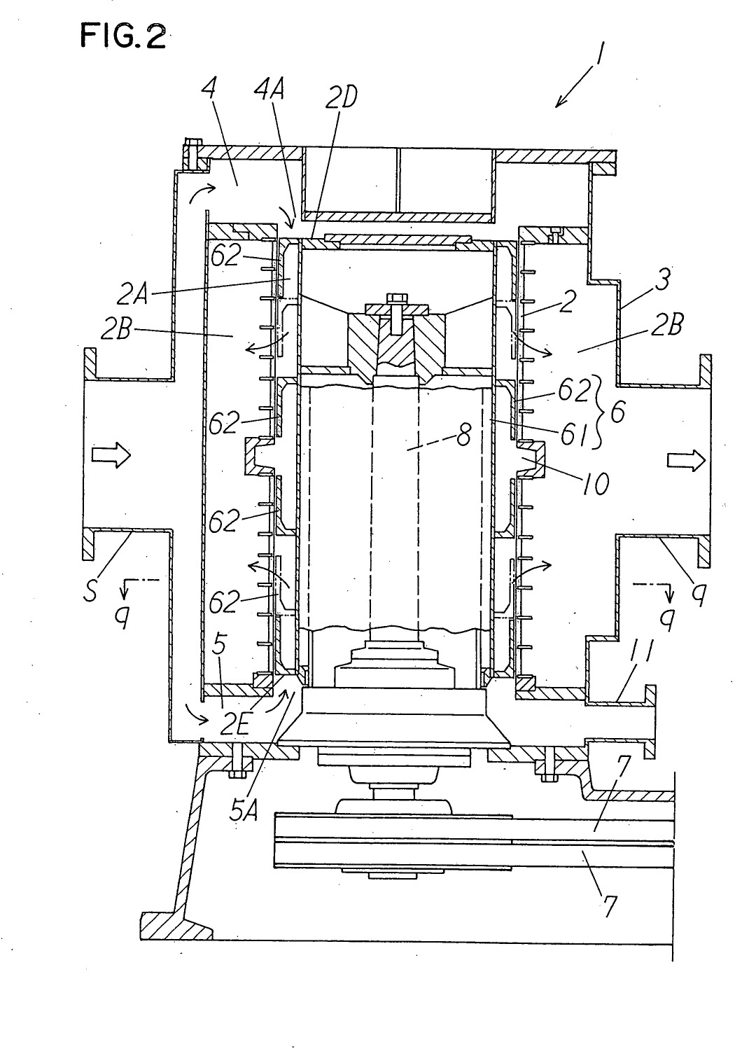

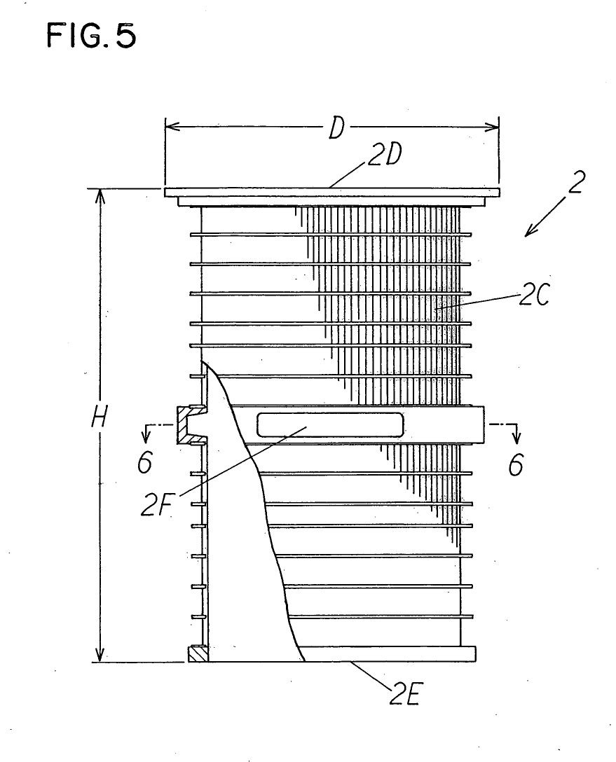

The screen device 1 includes a tank 3 receiving the papermaking material. The tank 3 is divided by the screen 2 into a first chamber 2A receiving the papermaking material and a second chamber 2B receiving a refined papermaking material. As shown in FIG. 5, the screen 2 has a cylindrical shape whose height H is longer than a diameter D (D<H) with both open end portions, and the side face of the screen 2 includes slit-like openings 2C (or circular holes). The screen 2 stands inside the tank 3 in such a way that the direction of the height H orients in a vertical direction (refer to FIG. 2). Both open end portions of the screen 2 are an upper opening 2D and a lower opening 2E.

The above-mentioned screen 2 is made as D<H, because D<H is more efficient compared to D>H or D=H. More specifically, in case the screen with D<H has a diameter D (for example, 0.4 m), the height H (for example, 0.9 m), and a revolution N (540 rpm) of an agitating member, the flow passing through the screen 2 is Q, and the power required for the flow is P1. Also, in case the screen with D=H has a diameter d (for example, 0.6 m), height h (for example, 0.6 m), and a revolution n (812 rpm) of the agitating member, the flow passing through the screen 2 is Q, and the power required for the flow is P2. According to the calculation formula, the relationship between the P1 and P2 is as follows.

$$\begin{matrix}P 2 = {( d / D )}^{5} \times {( n / N )}^{3} \times ( h / H ) \times P 1 \\ = 0.67 \times P 1\end{matrix}$$

Therefore, the power saved is approximately 30%.

The reference numeral 4 shown in FIG. 2 represents a first papermaking material supply passage supplying the papermaking material to the first chamber 2A from the upper side and including a first papermaking material supply opening 4A located on the upper side of the first chamber 2A. The reference numeral 5 shown in FIG. 2 represents a second papermaking material supply passage supplying the papermaking material to the first chamber 2A from the lower side and including a second papermaking material supply opening 5A located lower than the first papermaking material supply opening 4A. The first papermaking material supply opening 4A is located higher than the upper opening 2D, and the second papermaking material supply opening 5A is located lower than the lower opening 2E, respectively.

The upstream side of the first papermaking material supply passage 4 and the second papermaking material supply passage 5 is a shared supply passage S. Incidentally, in the embodiment, one supply passage S is divided into the first papermaking material supply passage 4 and the second papermaking material supply passage 5. However, the supply passage S may be provided separately without sharing depending on conditions.

The reference numeral 6 shown in FIG. 2 represents the agitating member located inside the first chamber 2A on the inner side of the screen 2 and agitating the papermaking material inside the tank 3. The agitating member 6 includes, for example, multiple agitating portions 62 attached to a side face of a cylindrical rotational body portion 61. The body portion 61 rotates by the rotation from a motor, not shown, in the figures through belts 7 and a rotational axis 8.

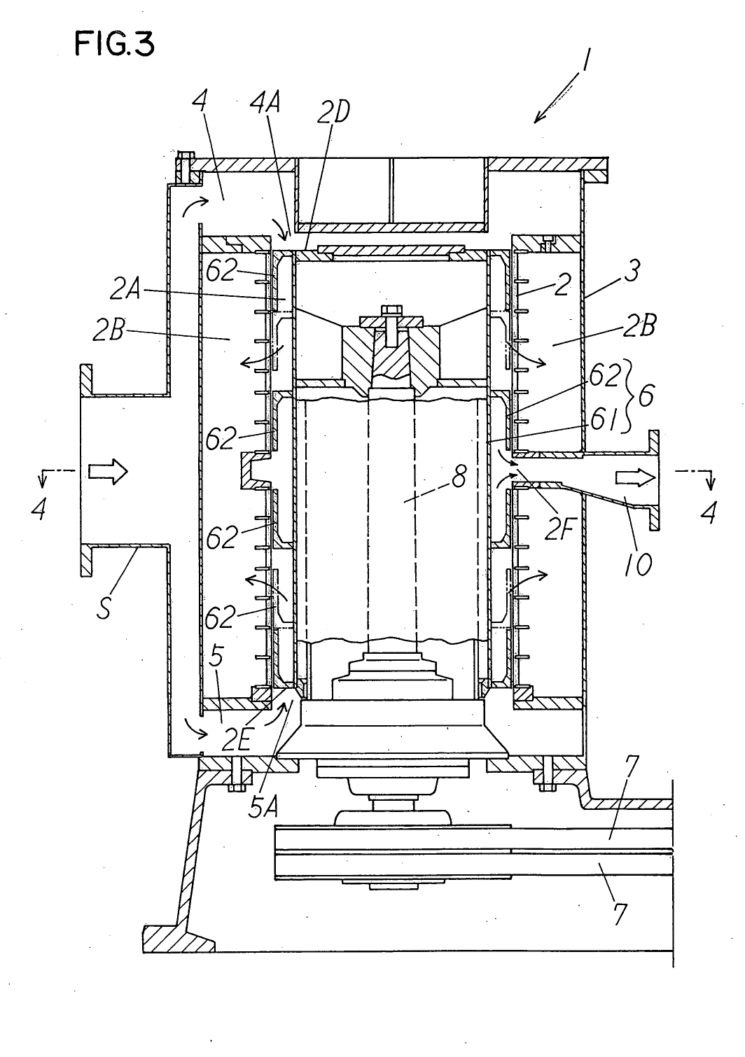

The reference numeral 9 shown in FIG. 2 represents a refined papermaking material outlet passage communicated with the second chamber 2B receiving the papermaking material which passed through the openings 2C (slits or circular holes) of the screen 2, and leading the refined papermaking material through the screen 2 to the outside of the tank 3. Also, the reference numeral 10 shown in FIG. 3 represents a foreign material outlet passage communicating with the first chamber 2A through a foreign material outlet 2F provided on the side face of the screen S, and leading the foreign material in the papermaking material which does not pass through the screen S to the outside of the tank 3.

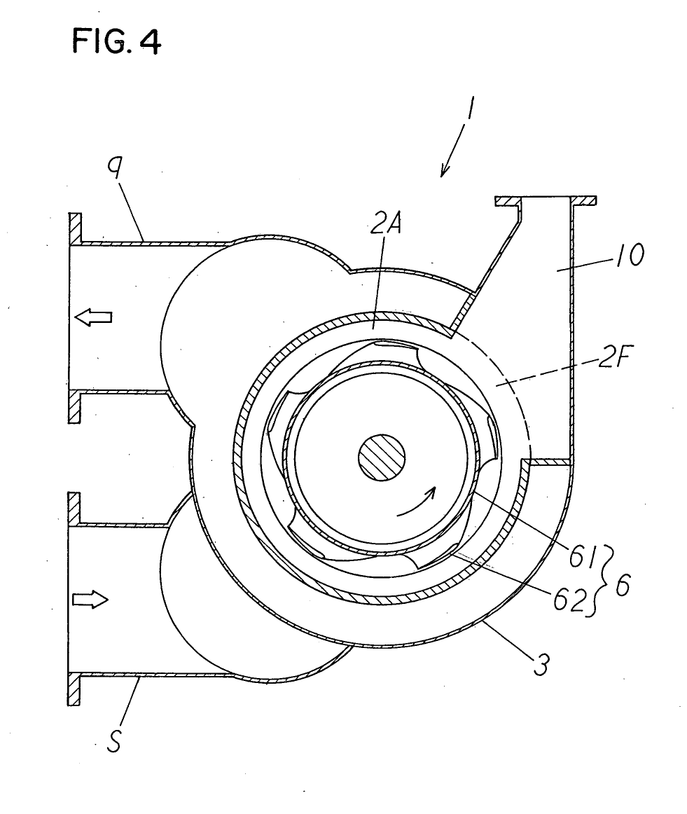

Optimally, the foreign material outlet 2F is located at half the height of the screen 2, and formed in an arc shape along the outer circumference of the screen 2 as shown in FIGS. 4-8, so that the foreign material (for example, relatively lightweight foreign material) in the papermaking material can be efficiently collected in a position of half the height of the screen 2. Also, the opening area of the foreign material outlet 2F is provided widely, so that clogging of the foreign material outlet 2F can be also prevented. Incidentally, the reference numeral 11 shown in FIG. 2 represents a weight foreign material outlet passage communicated with the first chamber 2A, and leading a relatively heavy foreign material in the papermaking material which does not pass through the screen S to the outside of the tank 3.

Therefore, the papermaking material is supplied into the tank 3 by the first papermaking material supply passage 4 and the second papermaking material supply passage 5 through the supply passage S. When the rotation from the motor, not shown in the figures, is transmitted through the belts 7 and rotational axis 8, and the agitating member 6 rotates, the foreign material in the papermaking material cannot pass through the screen S, so that the foreign material is accumulated inside the first chamber 2A, and the papermaking material which passed through the screen S is led to the outside of the tank 3 through the second chamber 2B and refined papermaking material outlet passage 9.

Conventionally, in the so-called outward-type screen device allowing the papermaking material to flow toward the outside of the screen from the inside of the screen, and refining the papermaking material, as the papermaking material goes toward the bottom of the tank, the papermaking material is condensed, so that the sorting effect by the screen deteriorates.

However, according to the screen device 1 of the embodiment, the first papermaking material supply opening 4A is located higher than the upper opening 2D of the screen 2, and the second papermaking material supply opening 5A is located lower than the lower opening 2E of the screen 2, respectively. Since the foreign material outlet passage 10 communicated with the first chamber 2A through the foreign material outlet 2F provided on the side face of the screen 2, and leading the foreign material in the papermaking material which does not pass through the screen 2 to the outside of the tank 3 is provided, in the so-called outward-type screen device allowing the papermaking material to flow toward the outside of the screen 2 from the inside of the screen 2, and refining the papermaking material, the distance between the supply opening (upper opening 2D or lower opening 2E) to the screen 2 of the papermaking material and the outlet (foreign material outlet 2F) shortens. Thus, the papermaking material is hard to be condensed, and refining efficiency can be improved.

Incidentally, in the foreign material outlet passage 10 and weight foreign material outlet passage 11, a valve for opening and closing the passage, not shown in the figures, adjusts the opening, or by adjusting the opening and closing accordingly, the foreign material accumulated inside the first chamber 2A is led to the outside of the tank 3.

In the above-mentioned embodiment, dilution water is not introduced into the first chamber 2A. However, as shown in FIG. 10, the dilution water may be introduced into the first chamber 2A. Also, in the embodiment, diameters of the body portions 61 of the agitating member 6 have the same size. However, as shown in FIG. 10, the size may be different. Incidentally, in FIG. 10, the same symbols are used for the same portions as the above embodiment, and the explanation is partly omitted.

More specifically, the reference numeral 20 shown in FIG. 10 represents a first dilution water passage communicated with the first chamber 2A through a first dilution water inlet 2G provided on the side face of the screen 2 and leading the dilution water into the screen 2. The reference numeral 30 shown in FIG. 10 represents a second dilution water passage communicated with the first chamber 2A through a second dilution water inlet 2H provided on the side face of the screen 2 and leading the dilution water into the screen 2. The first dilution water inlet 2G is located higher than the foreign material outlet 2F, and the second dilution water inlet 2H is located lower than the foreign material outlet 2F.

Also, the agitating member 6 includes a first cylinder portion 61′ including multiple first agitating portions 62′ on the side face; a second cylinder portion 61″ including multiple second agitating portions 62″ on the side face; and a third cylinder portion 61′″ including multiple third agitating portions 62′″ on the side face, sequentially from the top to the bottom of the tank 3. The foreign material outlet 2F is located in a position facing the second cylinder portion 61″. The first dilution water inlet 2G is located closer to the foreign material outlet 2F than the upper opening 2D (h₀<h₁) in the direction of the height of the screen 2, and the second dilution water inlet 2H is located closer to the foreign material outlet 2F than the lower opening 2E (H₀′<h₁′) in the direction of the height of the screen 2, respectively.

The interval W₁ between the screen 2 and the second cylinder portion 61″ is larger than the interval W₂ between the screen 2 and the first cylinder portion 61′ and the interval W₃ between the screen 2 and the third cylinder portion 61′″. As a result, as the space receiving the dilution,water increases, the dilution effect of the condensed papermaking material can be enhanced and the refining efficiency can be improved.

Therefore, as in the case of the screen device 1 in FIGS. 1-9, in the screen device 1 in FIG. 10, the papermaking material is supplied into the tank 3 by the first papermaking material supply passage 4 and the second papermaking material supply passage 5 through the supply passage S. When the rotation from the motor, not shown in the figures, is transmitted through the belt, not shown in the figures, and the rotational axis 8, and the agitating member 6 rotates, the foreign material in the papermaking material cannot pass through the screen 2, so that the foreign material is accumulated inside the first chamber 2A, and the papermaking material which passed through the screen S is led to the outside of the tank 3 through the second chamber 2B and the refined papermaking material outlet passage 9.

Also, the first papermaking material supply opening 4A is located higher than the upper opening 2D of the screen 2, and the second papermaking material supply opening 5A is located lower than the lower opening 2E of the screen 2, respectively. Since the foreign material outlet passage 10 communicated with the first chamber 2A through the foreign material outlet 2F provided on the side face of the screen 2, and leading the foreign material in the papermaking material which does not pass through the screen 2 to the outside of the tank 3 is provided, in the so-called outward-type screen device allowing the papermaking material to flow toward the outside of the screen 2 from the inside of the screen 2, and refining the papermaking material, the distance between the supply opening (upper opening 2D or lower opening 2E) to the screen 2 of the papermaking material and the outlet (foreign material outlet 2F) shortens. As a result, the papermaking material is hard to be condensed, and the refining efficiency can be improved.

Incidentally, especially, the interval W₁ between the screen 2 and the second cylinder portion 61″ is larger than the interval W₂ between the screen 2 and the first cylinder portion 61′ and the interval W₃ between the screen 2 and the third cylinder portion 61′″. As a result, as the space receiving the dilution water from the first dilution water passage 20 and the second dilution water passage 30 increases, the dilution effect of the condensed papermaking material can be enhanced and the refining efficiency can be improved.

The disclosure of Japanese Patent Application No. 2006-076539 filed on Mar. 20, 2006 is incorporated herein as a reference.

While the present invention has been explained with reference to the specific embodiments of the invention, the explanation is illustrative, and the invention is limited only by the appended claims.

What is claimed is:

1. A screen device comprising:
a tank for receiving a papermaking material;
a cylindrical screen situated inside the tank for dividing the tank into a first chamber and a second chamber to sort a foreign material in the papermaking material, said screen having upper and lower open portions and side openings on a side face and standing vertically inside said tank;
a first papermaking material supply passage for supplying the papermaking material to the first chamber from the upper open portion;
a second papermaking material supply passage for supplying the papermaking material to the first chamber from the lower open portion;
an agitating member located on an inner side of the screen in the first chamber for agitating the papermaking material inside the tank;
a refined papermaking material outlet passage communicated with the second chamber for leading the papermaking material refined through the screen to an outside of the tank; and
a foreign material outlet passage communicated with the first chamber through a foreign material outlet provided on the side face of the screen for leading the foreign material in the papermaking material which does not pass through the screen to the outside of the tank.

2. A screen device according to claim 1, wherein said screen has a height longer than a diameter, and the side opening has a circular hole or slit-like opening.

3. A screen device according to claim 2, wherein said first papermaking material supply passage includes a first papermaking material supply opening located above the upper open portion of the first chamber, and said second papermaking material supply passage includes a second papermaking material supply opening located lower than the lower open portion.

4. A screen device according to claim 1, wherein the foreign material outlet provided on the side face of the screen is located at half the height of the screen, and formed in an arc shape along an outer circumference of the screen.

5. A screen device according to claim 1, further comprising:
a first dilution water passage having a first dilution water inlet provided on the side face of the screen and communicated with the first chamber therethrough for leading the dilution water into the screen, said first dilution water inlet being located higher than the foreign material outlet; and
a second dilution water passage having a second dilution water inlet provided on the side face of the screen and communicated with the first chamber therethrough for leading the dilution water into the screen, said second dilution water inlet being located lower than the foreign material outlet.

6. A screen device according to claim 1, wherein said agitating member comprises:
a first cylinder portion including multiple first agitating portions on a side face thereof;
a second cylinder portion including multiple second agitating portions on a side face thereof; and
a third cylinder portion including multiple third agitating portions on a side face thereof, said first to third cylinder portions being formed sequentially from a top to a bottom of the tank.

7. A screen device according to claim 6, wherein said foreign material outlet is located in a position facing the second cylinder portion, and a distance between the screen and the second cylinder portion is larger than a distance between the screen and the first cylinder portion and a distance between the screen and a third cylinder portion.

8. A screen device according to claim 1, wherein said foreign material outlet is located in a middle area between the upper and lower open portions of the screen and entirely surround the screen.
